(19) United States
(12) Patent Application Publication
(10) Pub. No.: US 2025/0370596 A1
(43) Pub. Date: Dec. 4, 2025

(54) SMART TAB LANDING IN AN APPLICATION

(71) Applicant: Google LLC, Mountain View, CA (US)

(72) Inventors: Wael Hussain Al Saeed, Mountain View, CA (US); Zhiwei Gu, Cupertino, CA (US); Ramkumar Rajendran, Campbell, CA (US); Jiahui Liu, Saratoga, CA (US); Will Xi Zhou, Burlingame, CA (US); Linda K. Nguyen, Mountain View, CA (US)

(21) Appl. No.: 18/680,588

(22) Filed: May 31, 2024

(51) Int. Cl. G06F 3/0484; G06F 9/451

(52) U.S. Cl. CPC G06F 3/0484; G06F 9/451

(57) ABSTRACT

A computing device is configured to obtain information for an application. The computing device is further configured to generate, using a machine learning model and based on the usage information, at least one intent score. The computing device is further configured to determine, based on the at least one intent score, one or more navigation settings for the application, wherein the one or more navigation settings indicate a particular page that the application should open upon launching of the application. The computing device is further configured to cause, upon launching of the application, the application to open the particular page.

### BACKGROUND

Computing devices, such as mobile computing devices, may run a variety of software applications that extend existing device capabilities and add new capabilities. Many types of applications are generally available, such as applications for information retrieval, communications and entertainment. Applications may be available for user access and download to a user device via an application such as a storefront application.

### SUMMARY

Techniques are described by which a computing device may determine which page of an application (e.g., an application store, a storefront application, a marketplace application, travel application) to display to a user upon launching of the application. In accordance with techniques of this disclosure, a computing device may obtain usage information regarding the application such as which pages of the application a user spent the most time interacting with. The computing device may generate at least one intent score using a machine learning model that reflects user interest in one or more pages of the application (e.g., which set of pages the user would be most interested in interacting with). The computing device determines one or more navigation settings for the application based on the at least one intent score. The computing system may determine navigation settings for the application that dictate which page of the application should open upon launching of the application (e.g., for an application store, opening a page showing applications or a page showing games). The computing system causes the application to open the particular page of the application upon launching of the application. In this way, the computing device may optimize which page of an application is displayed upon the launching of the application to improve the user experience of using the application.

In some examples, a method includes obtaining, by a computing device, usage information for an application; generating, by the computing device and using a machine learning model and based on the usage information, at least one intent score; determining, by the computing device and based on the at least one intent score, one or more navigation settings for the application, wherein the one or more navigation settings indicate a particular page that the application should open upon launching of the application; and causing, by the computing device and upon launching of the application, the application to open the particular page.

In some examples, a computing system includes a memory and one or more programmable processors in communication with the memory and configured to obtain usage information for an application; generate, using a machine learning model and based on the usage information, at least one intent score; determine, based on the at least one intent score, one or more navigation settings for the application, wherein the one or more navigation settings indicate a particular page that the application should open upon launching of the application; and cause, upon launching of the application, the application to open the particular page.

In some examples, a non-transitory computer-readable storage medium stores instructions that, when executed by one or more processors of a computing device, cause one or more processors of a computing device to obtain usage information for an application; generate, using a machine learning model and based on the usage information, at least one intent score; determine, based on the at least one intent score, one or more navigation settings for the application, wherein the one or more navigation settings indicate a particular page that the application should open upon launching of the application; and cause, upon launching of the application, the application to open the particular page.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing system for determining navigation settings for an application, in accordance with one or more aspects of the present disclosure.

FIG. 2 is a block diagram illustrating details of a computing device for determining navigation settings for an application, in accordance with one or more techniques of this disclosure.

FIG. 3 is a block diagram illustrating details of a computing system for determining navigation settings for an application, in accordance with one or more techniques of this disclosure.

FIGS. 4A-4B are conceptual diagrams illustrating graphical user interfaces of an application, in accordance with one or more techniques of this disclosure.

FIG. 5 is a flow diagram illustrating example operations of an example computing device for determining navigation settings for an application, in accordance with one or more techniques of the present disclosure.

### DETAILED DESCRIPTION

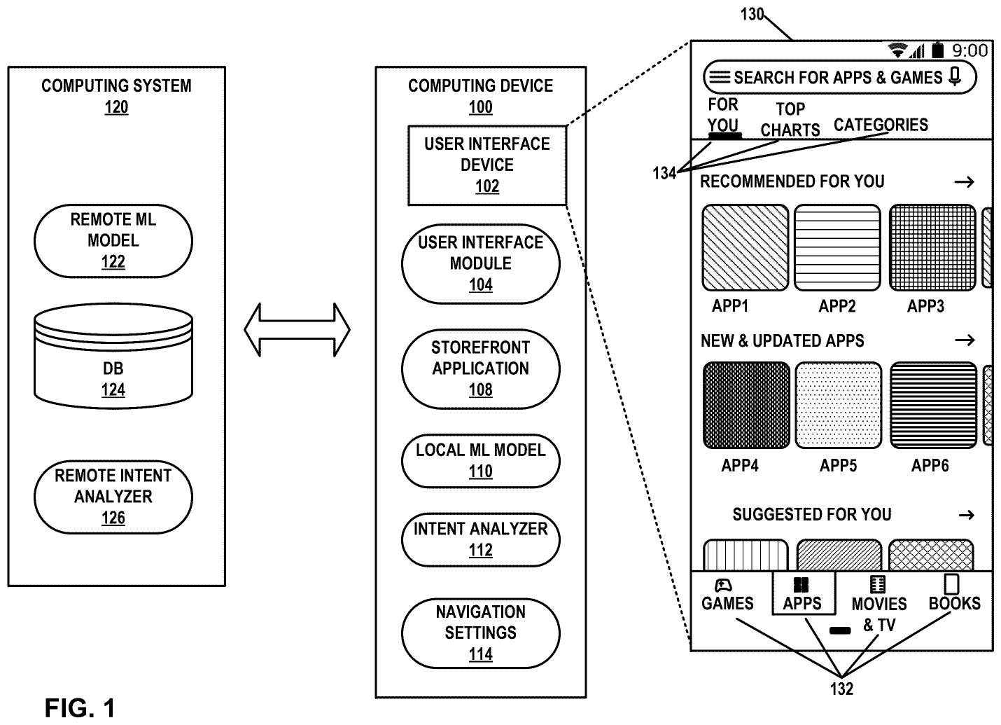

FIG. 1 is a conceptual diagram illustrating an example computing system for determining navigation settings for an application in accordance with one or more techniques of this disclosure. As shown in the example of FIG. 1, the computing system includes computing device 100 and computing system 120. Examples of computing devices 100 may include, but are not limited to, portable, mobile, or other devices, such as mobile phones (including smartphones), wearable computing devices (e.g., smart watches, smart glasses, etc.) laptop computers, desktop computers, tablet computers, smart television platforms, server computers, mainframes, infotainment systems (e.g., vehicle head units), etc.

Computing device 100 may include a plurality of software and/or hardware components. Examples of computing system 120 may include, but are not limited to server computers, mainframes, cloud compute nodes, distributed computing environments, and virtualized computing environments.

As shown in the example of FIG. 1, computing device 100 includes one or more user interface devices such as user interface (“UI”) device 102. UI device 102 of computing device 100 may be configured to function as an input device and/or an output device for computing device 100. UI device 102 may be implemented using various technologies. For instance, UI device 102 may be configured to receive input from a user through tactile, audio, and/or video feedback. Examples of input devices include a presence-sensitive display, a presence-sensitive or touch-sensitive input device, a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive technology. That is, UI device 102 of computing device 100 may include a presence-sensitive device that may receive tactile input from a user of computing device 100. UI device 102 may receive indications of the tactile input by detecting one or more gestures from the user (e.g., when the user touches or points to one or more locations of UI device 102 with a finger or a stylus pen).

UI device 102 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, miniLED, microLED, organic light-emitting diode (OLED) display, e-ink, or similar monochrome or color display capable of outputting visible information to a user of computing device 100. Additional examples of an output device include a speaker, a haptic device, or other device that can generate intelligible output to a user. For instance, UI device 102 may present output to a user of computing device 100 as a graphical user interface that may be associated with functionality provided by computing device 100. In this way, UI device 102 may present various user interfaces of applications executing at or accessible by computing device 100 (e.g., an electronic message application, an Internet browser application, a storefront application, a marketplace application, etc.). A user of computing device 100 may interact with a respective user interface of an application to cause computing device 100 to perform operations relating to a function.

In some examples, UI device 102 of computing device 100 may detect two-dimensional and/or three-dimensional gestures as input from a user of computing device 100. For instance, a sensor of UI device 102 may detect the user's movement (e.g., moving a hand, an arm, a pen, a stylus, etc.) within a threshold distance of the sensor of UI device 102. UI device 102 may determine a two- or three-dimensional vector representation of the movement and correlate the vector representation to a gesture input (e.g., a hand-wave, a pinch, a clap, a pen stroke, etc.) that has multiple dimensions. In other words, UI device 102 may, in some examples, detect a multidimensional gesture without requiring the user to gesture at or near a screen or surface at which UI device 102 outputs information for display. Instead, UI device 102 may detect a multi-dimensional gesture performed at or near a sensor which may or may not be located near the screen or surface at which UI device 102 outputs information for display.

In the example of FIG. 1, computing device 100 includes user interface (UI) module 104. UI module 104 may perform operations described herein using hardware, software, firmware, or a mixture thereof residing in and/or executing at computing device 100. Computing device 100 may execute UI module 104 with one processor or with multiple processors. In some examples, computing device 100 may execute UI module 104 as a virtual machine executing on underlying hardware. In some examples, computing device 100 may include one or more programmable processors in communication with memory and configured to execute one or more instructions associated with the techniques of this disclosure. In some examples, computing device 100 may include a non-transitory computer-readable encoded with instructions that, when executed by one or more processors, cause the one or more processors to execute one or more techniques of this disclosure. UI module 104 may execute as one or more services of an operating system or computing platform or may execute as one or more executable programs at an application layer of a computing platform.

UI module 104, as shown in the example of FIG. 1, may be operable by computing device 100 to perform one or more functions, such as receiving input and sending indications of such input to other components associated with computing device 100, such as storefront application 108. UI module 104 may also receive data from components associated with computing device 100 such as storefront application 108. Using the data received, UI module 104 may cause other components associated with computing device 100, such as UI device 102, to provide output based on the data. For instance, UI module 104 may receive data from one or more application modules to display a graphical user interface (“GUI”).

Computing device 100 may communicate with other computing devices and/or systems such as computing system 120 via a network. The network may include any public or private communication network, such as a cellular network, Wi-Fi network, satellite communication network, or other type of network for transmitting data between computing devices. In some examples, the network may represent one or more packet switched networks, such as the Internet. Computing device 100 may send and receive data across the network using any suitable communication techniques. For example, computing device 100 may be operatively coupled to the network using respective network links. The network may include network hubs, network switches, network routers, terrestrial and/or satellite cellular networks, etc., that are operatively inter-coupled thereby providing for the exchange of information between computing device 100 and another computing device. In some examples, network links of the network may be Ethernet, ATM or other network connections. Such connections may include wireless and/or wired connections.

Computing device 100 may provide an execution environment for one or more applications such as storefront application 108. Storefront application 108 may be a software component of computing device 100 that includes one or more types of applications such as storefront applications, shopping applications, application store, travel application, and/or marketplace application among other types of applications. For example, storefront application 108 may be an application that enables a user of computing device 100 to obtain one or more other applications, books, visual media (television, movies, and other visual media) and/or games among other applications or media obtainable through storefront application 108 to obtain the applications and/or media for computing device 100. Storefront application 108 may enable a user to select one or more applications that they wish for computing device 100 to download. Responsive to an interaction by a user selecting one or more applications within storefront application 108, storefront application 108 may cause computing device 100 to download and install the selected one or more applications.

Storefront application 108 may generate a graphical user interface (GUI) such as GUI 130 for display by one or more components of computing device 100. Storefront application 108 may generate GUI 130 as including one or more visual elements such as navigation indicators, search bars, application icons, advertisements, text boxes, and other visual elements. In addition, storefront application 108 may generate GUI 130 as including one or more visual elements such as tabs 132 and sub-tabs 134. GUI 130 may include tabs 132 as visual elements that enable a user to navigate between different pages of GUI 130. For example, GUI 130 may include tabs 132 that include tabs that correspond to pages of GUI 130 regarding games, applications, visual media (e.g., movies & TV), and books. In an example, UI device 102 receives user interaction consistent with the user interacting with a tab 132 labeled as “BOOKS”. Storefront application 108 generates UI 130 as including a page that includes information about one or more books available for purchase and/or download via storefront application 108.

GUI 130 may include sub-tabs 134 that enable navigation within the pages associated with tabs 132. Storefront application 108 generates the page as including sub-tabs 134 to enable a user to navigate one or more sub-pages of a particular page associated with one of tabs 132. For example, storefront application 108 may generate GUI 130 as including a particular page. Storefront application 108 may generate the page as including one or more sub-tabs 134 with each respective sub-tab 134 associated with a sub-page of the page. In an example, storefront application 108 generates GUI 130 as including a selected tab of tabs 132 associated with applications and displaying a page illustrating various applications available for download. In addition, storefront application 108 generates GUI 130 as including the visual indicators of three sub-tabs of sub-tabs 134 to enable a user to navigate to different sub-pages of the page associated with the application tab of tabs 132. In the example, storefront application 108 generates GUI 130 as including sub-tabs 134 associated with sub-pages of applications selected based on user preferences (e.g., “FOR YOU” sub-tab), top downloaded applications (e.g., “TOP CHARTS” sub-tab), and different categories of applications (e.g., “CATEGORIES” sub-tab).

In general, a user may use an application such as storefront application 108 to discover and obtain new applications, games, and other media for use and consumption via computing device 100. For example, a user may use storefront application 108 to discover new applications that they would like to use. However, a user may find it challenging to navigate storefront application 108. Furthermore, a user may even be unaware of different pages of storefront application 108 and the existence of tabs 132 and sub-tabs 134 that enable navigation between different pages and sub-pages of storefront application 108. Further, due to being unaware of other pages of storefront application 108 a user may fail to update one or more applications executed by computing device 100.

While described in the context of a storefront application and a media streaming application, the techniques of this disclosure may be applied to any application with a tabbed interface. For example, a user may use an application such as a media streaming application to discover and stream media such as new movies, music, podcasts, and other types of media. The user may use the media streaming application without being aware of navigation tabs that enable navigation within the media streaming application, for instance to navigate to a page that includes podcasts available for streaming. In such an example, the user fails to avail themselves of a variety of features and content provided by the media streaming application due to being unaware of other pages of the media streaming application and how to navigate to them. In addition, the user may have no motivation to explore the other pages of the media streaming application to discover content that they may enjoy.

In accordance with the techniques of this disclosure, computing device 100 may include an intent analyzer 112 that determines navigation settings 114 for storefront application 108. Intent analyzer 112 may generate at least one intent score using local machine learning (“ML”) model 110 and determine navigation settings 114 based on the at least one intent score. In some examples, computing device 100 may receive information regarding navigation settings from a computing system such as computing system 120. In this way, the techniques may help a user navigate storefront application 108 and discover one or more pages of the GUI of storefront application 108. In turn, this may enable a user to more intelligently navigate GUI 130 of storefront application 108 and discover new applications, games, and/or media as well as ensure that applications already installed on computing device 100 receive important updates.

Computing device 100 may use intent analyzer 112 to determine an intent of a user of computing device 100. Intent analyzer 112 may be a process, application, plugin, module, or other type of software component. Intent analyzer 112 may use usage information to determine an intent of the user in the context of what type of page of an application that the user is seeking. For example, intent analyzer 112 may determine whether the user is seeking applications, games, books, or visual media such as movies from storefront application 108. Intent analyzer 112 may determine what type of page the user is seeking and cause storefront application 108 to generate a GUI that includes the type of page determined by intent analyzer 112. In some examples, intent analyzer 112 may determine categories of user interest. For example, intent analyzer 112 may determine an intent score for a games category (e.g., user interest in seeking games) and an intent score for an app category (e.g., the user seeking applications).

Intent analyzer 112 may receive usage information such as information regarding how the user uses storefront application 108 and one or more other applications executed by computing device 100. Intent analyzer 112 may receive usage information from one or more sources such as an external computing system or from one or more processes executed by computing device 100. For example, intent analyzer 112 may receive usage information that includes information about the applications installed on computing device 100 at the request of the user, what pages of storefront application 108 the user visits, how often the user interacts with storefront application 108, how long it has been since the user last interacted with storefront application 108, what types of applications the user uses on computing device 100, what applications, games, or other content the user has obtained from storefront application 108, clicks within storefront application 108, installations of other applications searches within storefront application 108, historical use information of storefront application 108, and other information. Intent analyzer 112 may receive usage information collected from the applications installed on computing device 100 if a user of computing device 100 has opted into sharing the collected information. Intent analyzer 112 may receive usage information that includes information regarding user in-session activities on computing device 100.

Intent analyzer 112 may process the usage information using one or more machine learning (ML) models such as local ML model 110. Local ML model 110 may include one or more ML models trained to determine an intent of a user and generate one or more intent scores that reflect the intent of the user. Local ML model 110 may be trained without using an intent label or with one or more intent labels, where the intent labels are representative of historical sessions of user interactions with storefront application 108. Local ML model 110 may include one or more ML models such as feed forward networks, shared tower models, neural networks, deep learning networks, and other types of ML models. Intent analyzer 112 may use local ML model 110 to process the usage information and generate at least one intent score that reflects an intent of the user in seeking one or more pages of an application. For example, intent analyzer 112 may use local ML model 110 to generate an app intent score that reflects the intent of the user to interact with application-focused pages of storefront application 108 and a game intent score that reflects the intent of the user to interact with game-focused pages of storefront application 108. Intent analyzer 112 may provide usage information to local ML model 110 and obtain an output from local ML model 110. Intent analyzer 112 may obtain an output from local ML model 110 that includes at least one intent score. For example, intent analyzer 112 may obtain an output of local ML model 110 that includes an application intent score and a games intent score.

Local ML model 110 may be a shared tower ML model that includes one or more towers. Local ML model 110 may include a first independent tower for determining a first intent score such as a game intent score and a second independent tower for determining a second intent score such as an application intent score. In some examples, intent analyzer 112 may use local ML model 110 to generate a plurality of intent scores.

Intent analyzer 112 may use local ML model 110 to generate one or more intent sub-scores that are indicative of user interest or intent within a particular intent. Intent analyzer 112 may generate intent sub-scores for one or more intent scores. Additionally, intent analyzer 112 may generate intent sub-scores that are indicative of user interest within categories of user interest. For example, intent analyzer 112 may generate intent sub-scores within categories such as a game category (e.g., an action game category, a puzzle game category, etc.) and an app category (e.g., a shopping application category, a productivity application category, etc.). In an example, intent analyzer 112 uses local ML model 110 to determine one or more game intent sub-scores for a game intent score. Intent analyzer 112 uses local ML model 110 to determine an action game intent sub-score, a puzzle game intent sub-score, and an online game intent sub-score, where each of the game intent sub-scores reflects a particular genre of game.

Intent analyzer 112 may use local ML model 110 to generate intent sub-scores that are based on user segmentation and that are sub-scores of the intent scores (e.g., subcomponents or specialized intent scores). Intent analyzer 112 may obtain information regarding segmentation of a plurality of users of storefront application 108 such as one or more categories and/or segments of users of storefront application 108. For example, intent analyzer 112 may obtain information regarding a plurality of user segments of users who regularly access game-focused pages of storefront application 108 or who play games obtained from storefront application (e.g., a user segment of users who primarily play role-playing games, a user segment of users who regularly browse platforming games in storefront application 108, etc.). Intent analyzer 112 may use local ML model 110 to generate intent sub-scores that correspond to segments of users to further optimize the page of storefront application 108 that is displayed upon launching of storefront application 108.

Intent analyzer 112 may determine one or more of navigation settings 114 for storefront application 108 based on the at least one intent score and any intent sub-scores. Navigation settings 114 may include one or more settings for applications executed by computing device 100 such as storefront application 108. Navigation settings 114 may include information such as which page storefront application 108 should open upon launching of storefront application 108. Navigation settings 114 may additionally include a second set of navigation settings regarding a particular subpage that storefront application 108 should open upon launching. Navigation settings 114 may further include information configuring other aspects of storefront application 108. For example, navigation settings 114 may include information configuring the behavior of storefront application 108 during execution.

Computing device 100 may record which page of storefront application 108 was last accessed by a user and determine whether to open the last accessed page or the page determined by intent analyzer 112. Computing device 100 may record which page of storefront application 108 was open when storefront application 108 was last executed by computing device 100 and when storefront application 108 was last executed. For example, computing device 100 may determine which page of storefront application 108 was accessed in an immediately preceding period of time. Computing device 100 may determine whether a predetermined period of time (e.g., 1 day, 1 week, 2 weeks, 1 month, etc.) has elapsed since storefront application 108 was last opened in order to determine whether to open the previously opened page or a page determined by intent analyzer 112. In an example, computing device 100 determines that storefront application 108 was last opened two weeks ago and that a “books” page was the page that was last open. Computing device 100 determines that, based on the elapsed period of time, that storefront application 108 should open a page determined by intent analyzer 112 instead of the last opened page. In another example, computing device 100 determines that storefront application 108 was last opened two days ago to a “games” page. Computing device 100 determines that a two week threshold period of time has not elapsed since storefront application 108 was last opened and causes storefront application 108 to open to the “games” page instead of a page determined by intent analyzer 112.

In some examples, computing device 100 may configure navigation settings 114 to cause storefront application 108 to open to a particular page instead of opening to a page determined by intent analyzer 112. For example, computing device 100 may receive an indication from computing system 120 or another computing system to cause storefront application 108 to open to a particular page. Computing device 100 may receive an indication to configure navigation settings 114 to encourage the user to explore the pages of storefront application 108 (e.g., for storefront application 108 to open to a page that the user has never visited). Responsive to the receipt of the indication, computing device 100 updates navigation settings to cause storefront application 108 to open to the particular page when launched.

In some examples, computing system 120 may determine which page storefront application 108 should open upon launching of storefront application 108. For example, computing system 120 may determine which page storefront application 108 should open and provide information regarding the determination to computing device 100. In some examples, computing system 120 may work in tandem with computing device to determine which page storefront application 108 should open upon launching and configure navigation settings 114 accordingly. Computing device 100 may obtain an indication of which page storefront application 108 should be opened upon launch of storefront application 108 from computing system 120. For example, computing device 100 may provide usage information to computing device 100 and receive an indication of a particular page that storefront application 108 should open from computing system 120.

Computing system 120 may use remote intent analyzer 126 to determine the intent of the user of computing device 100. Remote intent analyzer 126 may be similar to intent analyzer and perform similar functions. For example, remote intent analyzer 126 may determine at least one intent score using an ML model such as remote ML model 122.

Computing system 120 may execute one or more ML models such as remote ML model 122. Remote ML model 122 may be similar to local ML model 110 and similarly be an ML model trained to determine intent scores. For example, remote ML model 122 may process usage information obtained from computing device 100 and output one or more intent scores determined based on the usage information.

Computing system 120 may store information such as usage information obtained from computing device 100 in database 124 (illustrated as “DB 124” in FIG. 1). Computing system 120 may obtain information from computing device 100 or one or more other computing devices/systems (e.g., one or more servers associated with storefront application 108) and store the information in database 124. Computing system 120 may use the information stored in database 124 to generate intent scores and provide indications to update navigation settings 114 of computing device 100.

Storefront application 108 may obtain information from navigation settings 114 before generating a user interface such as GUI 130. Storefront application 108 may poll navigation settings 114 in response to computing device 100 beginning to execute the instructions of storefront application 108. For example, storefront application 108 may obtain information from navigation settings 114 as part of a startup process of storefront application 108. Storefront application 108 may obtain information from navigation settings 114 prior to generating a user interface such as GUI 130 to determine which page should be first displayed to a user. For example, upon launching storefront application 108 may generate GUI 130 as set to a particular page indicated by navigation settings 114.

Responsive to obtaining information from navigation settings 114, storefront application 108 generates GUI 130. Storefront application 108 may generate GUI 130 as including the page indicated by navigation settings 114. For example, storefront application 108 may generate GUI 130 as including an application page indicated by navigation settings 114. In some examples, storefront application 108 may generate GUI 130 as including a subpage indicated by navigation settings 114.

Computing device 100 may output GUI 130 for display via one or more components. Computing device 100 may output GUI 130 for display in response to storefront application 108 generating GUI 130. Computing device 100 may output GUI 130 for display via UI device 102.

The techniques of this disclosure include one or more advantages. For example, storefront application 108 may use intent analyzer 112 to identify the page of storefront application 108 that a user is most likely to be interested in and display that page upon launch instead of requiring the user to navigate to that page, and in doing so improve the ability of computing device 100 to offer content that a user may be interested in. In another example, storefront application 108 may use intent analyzer 112 to improve the generation of GUIs by applications of computing device 100 by tailoring the configuration of the application GUIs to a user. In a further example, intent analyzer may improve the security of computing device 100 by causing a user to view the other pages of storefront application 108 and obtain updates for applications executed by computing device 100 via storefront application 108.

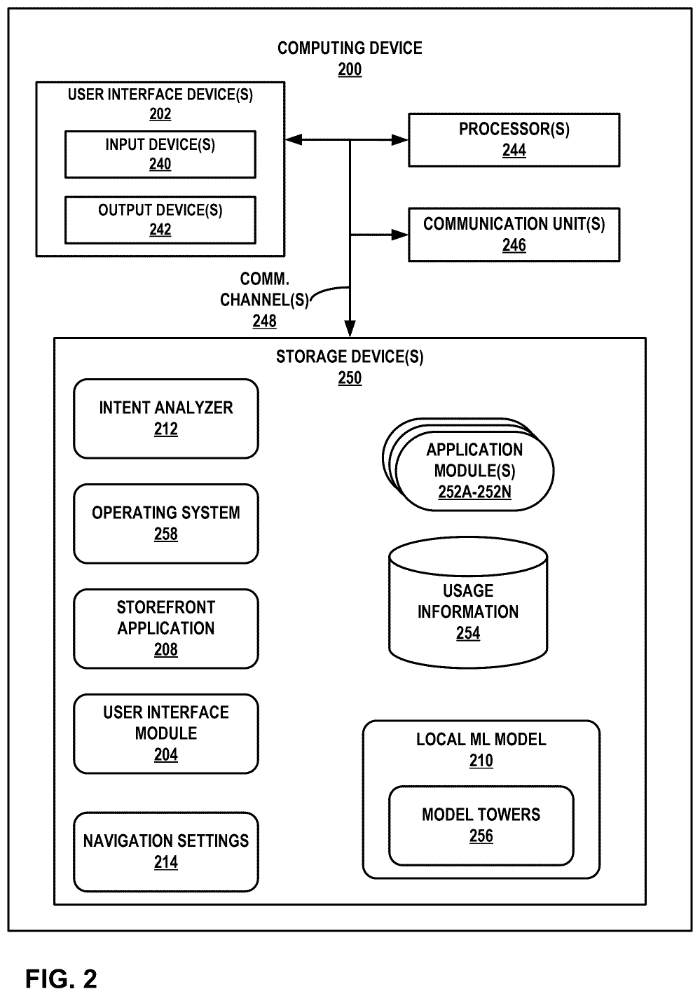

FIG. 2 is a block diagram illustrating details of a computing device for determining navigation settings for an application, in accordance with one or more techniques of this disclosure. In the example of FIG. 2, computing device 200 includes UI devices 202 (illustrated as “USER INTERFACE DEVICE(S) 202” in FIG. 2), processors 244, communication units 246, communication channels 248 (illustrated as “COMM. CHANNEL(S) 248 in FIG. 2), and storage devices 250. Examples of computing device 200 may include, but are not limited to, portable, mobile, or other devices, such as mobile phones (including smartphones), wearable computing devices (e.g., smart watches, smart glasses, etc.) laptop computers, desktop computers, tablet computers, smart television platforms, server computers, mainframes, infotainment systems (e.g., vehicle head units), etc. Computing device 200 may be similar to computing device 100 as illustrated in FIG. 1 and perform similar functions. In addition, computing device 200 may include a plurality of software and hardware components beyond those listed immediately above.

Computing device 200 may use UI devices 202 to enable computing device 200 to receive user input and provide output to one or more users. UI devices 202 may be implemented using various technologies. For instance, UI devices 202 may be configured to receive input from a user through tactile, audio, and/or video feedback. In another example, UI devices 202 may be configured to provide output to a user through tactile, audio, and/or video output.

UI devices 202 may include input devices 240 and output devices 242. Input devices 240 may include one or more devices and/or components configured to receive user input. For example, input devices 240 may include one or more input devices such as presence-sensitive displays, presence-sensitive or touch-sensitive input devices, mice, keyboards, voice responsive systems, video cameras, microphones, and/or any other types of devices for receiving input from a user. Output devices 242 may include one or more devices and/or components capable of generating output. For example, output devices 242 may include one or more output devices capable of generating tactile, video, and/or video output such as displays, speakers, haptic engines, light indicators, and/or any other types of devices capable of generating output. In some examples, UI devices 202 may include software components that process user input into data for consumption by other software and hardware components of computing device 200.

Computing device 200 may use one or more of processors 244 to implement functionality and/or execute instructions within computing device 200. Examples of processors 244 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used herein may refer to any of the foregoing structures or any other structure suitable for implementation of the techniques described herein.

Computing device 200 may use communication units 246 to communicate with one or more external devices via one or more wired and/or wireless networks by transmitting and/or receiving network signals on the one or more networks. Examples of communication units 246 may include a network interface card (e.g., such as an ETHERNET card), an optical transceiver, a radio frequency transceiver, a GPS receiver, a telephony interface, or any other type of device/interface that can send and/or receive information. Other examples of communication units 246 may include short wave radios, cellular data radios, wireless network radios, satellite communication radios, as well as universal serial bus (USB) controllers.

Computing device 200 may use communication channels 248 to facilitate communication between one or more components of computing device 200. Communication channels 248 may include one or more hardware and software communication channels and/or interfaces that interconnect one or more components and/or devices of computing device 200. For example, communication channels 248 may communicate instructions from storage devices 250 to processors 244 for execution by processors 244.

Computing device 200 may store instructions and information in storage devices 250. Storage devices 250 may include one or more types of computer-readable storage media. For example, storage devices 250 may include one or more types of non-volatile storage devices such hard disk drives, solid state drives, optical discs, magnetic tape drives, and cloud storage among other types of non-volatile storage. In addition, storage devices 250 may include one or more types of volatile storage such as random access memory (RAM), dynamic random access memory (DRAM), error correction code (ECC) memory, and static random access memory (SRAM) among other forms of volatile memory known in the art. Storage devices 250 may store instructions of one or more software components of computing device 200 such as user interface module 204. In some examples, storage devices 250 may include non-transitory computer-readable storage medium encoded with instructions executed by processors 244 that, when executed by processors 244, cause processors 244 to execute the instructions of one or more software components of computing device 200.

Storage devices 250 may include user interface module (“UIM”) 204. UIM 204 may be a program, plugin, module, software component, and/or process executed by processors 244. UIM 204 may perform one or more functions such as receiving input and sending indications of such input to other components associated with computing device 200. UIM 204 may also receive data from components of computing device 200 such as storefront application 208. For example, UIM 204 may process input data generated by input devices 240 in response to user interaction with input device 240 and provide the input data to an application of computing device 200. In another example, UIM 204 receives data from another process executed by computing device 200 and causes one or more of output devices 242 to generate output based on the received data.

Storage devices 250 may store information regarding application modules 252A-252N (hereinafter “application modules 252”). Application modules 252 may perform operations described herein using hardware, software, firmware, or a mixture thereof residing in and/or executing at computing device 200. Computing devices 200 may execute application modules 252 with one or more processors of processors 244. Application module 252 may include functionality to perform any variety of operations on computing device 200. For instance, application modules 252 may include a word processor, a text application, a web browser, a multimedia player, a calendar application, a distributed computing application, a graphic design application, a video editing application, a web development application, or any other application. One of application modules 252 may be a text message, Short Message Service (SMS), and/or Rich Communication Services (RCS) application. Application modules 252 may interact with storefront application 208 and enable and/or extend functionality for one or more features of storefront application 208. For example, application modules 252 may include a multimedia player that enables computing device 200 to play visual media acquired from storefront application 208.

Storage devices 250 may store information regarding one or more applications such as storefront application 208. Storefront application 208 may be similar to storefront application 108 as illustrated in FIG. 1 and perform similar functions. For example, storefront application 208 may include one or more types of applications such as storefront applications, shopping applications, application stores, travel applications, and/or marketplace applications among other types of applications. Storefront application 208 may enable a user of computing device 200 to obtain a variety of applications, media, and other content for computing device 200 as well as make purchases and other transactions such as purchasing food, airline tickets, reserving hotel rooms, and other transactions. For example, in response to user interaction storefront application 208 may download an application via one or more network interfaces of communication units 246. In another example, storefront application 208 may cause computing device 200 to obtain data regarding a movie via communication units 246. In yet another example, storefront application 208 may obtain data regarding one or more physical items available for purchase via storefront application 208 (e.g., clothing, electronics, food such as cookies or takeout, etc.) and cause output devices 242 to display a user interface that includes visual indicators of the items available for purchase via storefront application 208.

Storefront application 208 may include one or more pages that each include products/information offered by storefront application 208. For example, storefront application 208 may be a tabbed application with one or more tabs that enable navigation among the one or more pages of the application. Storefront application 208 may provide tabs that enable navigation to one or more pages of storefront application 208 that offers products such as applications, games, media, food, clothing, electronics, and other products. In addition, storefront application 208 may provide sub-tabs that enable navigation between sub-pages of storefront application 208. For example, storefront application 208 may provide sub-tabs to enable navigation between sub-pages that each display a different respective type of food within a food ordering page of storefront application 208.

Storage devices 250 may store information regarding the configuration of storefront application 208 in navigation settings 214. Navigation settings 214 may be a data structure, application module or plugin, subprocess, standalone application, or other type of process or storage. Navigation settings 214 may include information regarding one or more settings of storefront application 208. For example, navigation settings 214 may include information regarding a configuration of which page of storefront application 208 to display upon the launch of storefront application 208. Navigation settings 214 may store information regarding which page of storefront application to display and update the information in response to an indication from one or more hardware and/or software components of computing device 200 such as intent analyzer 212.

Storage devices 250 may store instructions of intent analyzer 212 for execution by one or more of processors 244. Intent analyzer 212 may be similar to intent analyzer 112 as illustrated in FIG. 1 and may provide similar functionality. For example, intent analyzer 212 may be a software component of computing device 200 configured to determine an intent of a user of computing device 200. Intent analyzer 212 may determine the intent of the user in the context of determining which page of storefront application 208 that the user is seeking and/or what type of offering of storefront application 208 the user is seeking. For example, intent analyzer 212 may determine that the user is seeking a page of storefront application that includes information regarding different games that can be obtained from storefront application 208 and installed on computing device 200. In another example, intent analyzer 212 determines that the user is seeking a particular type of Vietnamese takeout.

Intent analyzer 212 may use one or more types of information to determine intent scores that are numerical reflections of the intent of a user. Intent analyzer may use information such as historical information (e.g., information such as a record of the page of storefront application 208 that the user last visited and when the user last interacted with storefront application 208), what games and applications of computing device 200 that the user uses, what media the user consumes via computing device 200, what other applications have been installed on computing device 200, clicks (e.g., interactions with visual elements by a user) within storefront application 208, searches within storefront application 208 using a search tool, and other information. Additionally, intent analyzer 212 may obtain information that is stored off-device (e.g., information stored by one or more computing systems associated with storefront application 208) and/or information that is stored on device in usage information 254.

Storage devices 250 may store information in usage information 254 for use by one or more software components of computing device 200. Usage information 254 may include one or more records or other types of information stored in accordance with one or more types of data structure. For example, usage information 254 may include information such as records of the page of storefront application 208 that the user last visited and when the user last interacted with storefront application 208, what games and applications of computing device 200 that the user uses, what media the user consumes via computing device 200, and other information such as historical usage information of storefront application 208. Storefront application 208 and/or intent analyzer 212 may store information in usage information 254.

Intent analyzer 212 may use one or more ML models such as local ML model 210 to process information such as usage information 254. Local ML model 210 may be similar to local ML model 110 as illustrated in FIG. 1 and provide similar functionality. For example, local ML model 210 may be an ML model executed by one or more of processors 244 and configured to generate intent scores that are numerical reflections of user intent. In some examples, local ML model 210 may generate intent scores that are vectorized representations of customer intent. In additional examples, local ML model 210 may generate intent scores that are one or more other types of numerical reflections of customer intent. Local ML model 210 may include one or more types of machine learning models such as feed forward networks, shared tower models, neural networks, deep learning networks, and other types of ML models.

Local ML model 210 may include model towers 256 of a shared tower ML model. Model towers 256 may represent one or more independent towers of a shared tower ML model configured to generate the intent score, with each independent tower configured to generate a type of intent score that corresponds to a given intent. For example, model towers 256 may include a first independent tower for determining a game intent score that reflects a user seeking games and a second independent tower for determining an application intent score that reflects the user seeking applications. In another example, model towers 256 may generate an intent score that reflects a user's intent to seek games and an intent score that corresponds to a customer's intent to seek applications, where a first tower of model towers 256 generates the game intent score and a second tower of model towers 256 generates the application intent score. Model towers 256 may process usage information 254 provided by intent analyzer 212 and generate a game score using the first independent tower and the app intent score using the second independent tower. In some examples, model towers 256 may include a plurality of independent towers with each of the independent towers corresponding to a particular type of intent score. In another example, model towers 256 may include one or more sub-towers that are each associated with an independent tower and that are configured to generate intent sub-scores. Local ML model 210 processes the information using the one or more sub-towers and generates one or more intent sub-scores.

Intent analyzer 212 may use local ML model 210 to determine an intent of a user within one or more categories of intent. Intent analyzer 212 may generate intent sub-scores that reflect the intent of the user seeking a sub-page of storefront application 208 and/or a subset of offerings within a category of offerings of storefront application 208. For example, intent analyzer 212 may generate intent sub-scores that reflect the intent of the user seeking sub-pages such as particular sub-pages of games within a games page of storefront application 208 (e.g., a user seeking sub-pages dedicated to action games, strategy games, etc.), particular sub-pages of applications within an applications page of storefront application 208 (e.g., a user seeking sub-pages dedicated to travel applications, shopping applications, other types of applications, etc.), particular sub-pages of media within a media page of storefront application 208 (e.g., a user seeking sub-pages dedicated to movies, television shows, music videos, music, podcasts, and other types of media of the media available from storefront application 208). Intent analyzer 212 may use local ML model 210 to generate intent sub-scores in addition to generating intent scores. For example, intent analyzer 212 may use local ML model 210 to generate an intent sub-score that reflects a user seeking a winter jackets page of a women's clothing page of storefront application 208. In another example, intent analyzer 212 uses one or more sub-towers of local ML model 210 to generate a plurality of intent sub-scores that each reflect a user seeking a respective sub-page of the pages of storefront application 208. Intent analyzer 212 may receive the intent scores and intent sub-scores from the plurality of independent towers of local ML model 210.

Intent analyzer 212 may use the one or more intent scores and intent sub-scores, among other information, to determine which page of storefront application 208 that storefront application 108 should open upon launch. Intent analyzer 212 may determine which page of storefront application 208 should be opened upon launch based on one or more comparisons of the intent scores and intent sub-scores. For example, intent analyzer 212 may determine which intent score has the greatest numerical value of the one or more intent scores and determine that storefront application 208 should open a page associated with the intent score that has the greatest numerical value. In another example, intent analyzer 212 may determine whether any of the intent scores exceed a threshold value and determine which page that storefront application 208 should open based on which intent scores, if any, exceed the threshold value. In yet another example, intent analyzer 212 may weight one or more of the intent scores (e.g., weighting the application intent scores relatively more than the game intent scores) based on one or more factors and determine which intent score has the greatest numerical value. Intent analyzer 212 may weight an intent score and/or sub-score based on factors such as developer-determined weightings, usage characteristics of the user, and other information and determine which page storefront application 208 should open based on the weighted intent scores and/or intent sub-scores.

In some examples, intent analyzer 212 may use information regarding previous user interactions with storefront application 208 to determine which page of storefront application 208 should be opened upon launching of storefront application 208. Intent analyzer 212 may obtain information regarding which page of storefront application 208 was last accessed by a user and when the user last interacted with storefront application from usage information 254. Intent analyzer 212 may use the information regarding when the page was last accessed to determine whether the page was accessed within an immediately preceding period of time (e.g., a predetermined threshold of time such as one day, a week, ten days, etc.). Intent analyzer 212 may determine whether to assign the page as being a “sticky” page, where the “sticky” designation may override a determination of what page to display that is based on the intent scores. In an example, intent analyzer 212 determines that storefront application 208 was last launched three days prior and displayed a page regarding games when closed by the user. Based on the determination that the games page of storefront application 208 was last displayed when storefront application 208 closed three days prior, intent analyzer 212 assigns the games page a “sticky” designation and cause storefront application 208 to open the games page instead of a page determined using the intent scores. In another example, intent analyzer determines that storefront application 208 has been accessed within an immediately preceding period of time to a given moment in time. Responsive to determining that storefront application 208 has been accessed within the immediately preceding period of time, intent analyzer 212 determines which page of storefront application 208 was last accessed. Intent analyzer 212 causes storefront application 208 to open the page that was last accessed upon launching.

Intent analyzer 212 may determine whether to remove the assignment of a “sticky” designation for a page. Intent analyzer 212 may remove the assignment of “sticky” based on the user launching storefront application 208. For example, intent analyzer 212 may remove the assignment of “sticky” for a page in response to computing device 200 closing storefront application 208 in response to user input with a page other than the “sticky” page being the last page accessed by the user. In addition, intent analyzer 212 may remove the assignment of “sticky” based on a determination that the predetermined threshold of time has been exceeded. In an example, intent analyzer 212 has assigned a designation of “sticky” to a games page based on a determination that the games page was the last page of storefront application 208 accessed by a user within a predetermined threshold of five days. Intent analyzer 212 determines, as more than five days have elapsed since storefront application 208 was last launched, the designation of “sticky” should be removed and that the intent scores should be used to determine which page storefront application 208 should displayed upon launch of storefront application 208.

Intent analyzer 212 may modify one or more settings of navigation settings 214 based on the intent scores. Navigation settings 214 may be a software component that includes one or more types of information storage that store information regarding navigation settings/configuration of storefront application 208. For example, computing device 200 may maintain information regarding the configuration of storefront application 208 in navigation settings 214. Navigation settings 214 may include information regarding navigation settings such as which page of storefront application 208 should be opened upon launch of storefront application 208, which pages of storefront application 208 should be displayed to a user, and other settings of storefront application 208. Intent analyzer 212 may modify one or more settings of navigation settings 214 based on intent analyzer 212 determining which page of storefront application 208 should be opened upon launching of storefront application 208. In an example, intent analyzer 212 determines that storefront application 208 should open to a particular page associated with games offered by storefront application 208. Based on the determination, intent analyzer 212 updates one or more settings of navigation settings 214 to cause storefront application 208 to open to the particular page associated with games upon launching of storefront application 208. In another example, intent analyzer 212 generates an intent score that includes at least one intent sub-score. Intent analyzer 212 determines, based on the at least one intent score, one or more second navigation settings in addition to first navigation settings where the second navigation settings indicate a particular subpage that storefront application 208 should open upon launching of storefront application 208.

Storefront application 208 may obtain information from navigation settings 214 to determine which page of storefront application 208 to open upon launching. Storefront application 208 may obtain information such as an indication of a particular page and/or particular sub-page of storefront application 208 that should be opened in response to the launch of storefront application 208. For example, storefront application 208 may obtain an indication that a particular page is a “sticky” page from navigation settings 114 and generate a GUI that includes the particular “sticky” page of storefront application 208. In another example, storefront application 208 obtains information from navigation settings 214 that includes an indication of a page of storefront application 208 determined by intent analyzer 212 and obtains an indication that there is no page with a “sticky” designation. Based on the indication, storefront application 208 generates a GUI that includes the page of storefront application 208 and causes output device 242 to display the GUI.

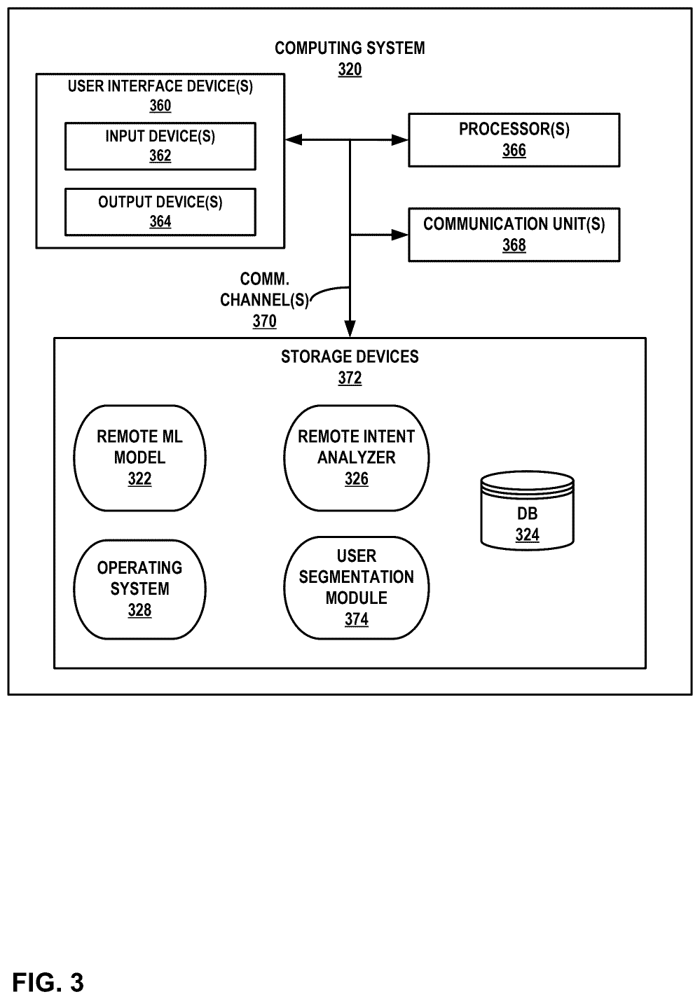

FIG. 3 is a block diagram illustrating details of a computing system for determining navigation settings for an application, in accordance with one or more techniques of this disclosure. Computing system 320 may be similar to computing system 120 as illustrated in FIG. 1 and provide similar functionality. For example, computing system 320 includes UI devices 360 (illustrated as “USER INTERFACE DEVICE(S) 360”), one or more of processors 366, communication units 368, communication channels 370 (illustrated as “COMM. CHANNEL(S) 370”), and one or more of storage devices 372. Examples of computing system 320 may include, but are not limited to server computers, mainframes, cloud compute nodes, distributed computing environments, and virtualized computing environments. For the purposes of clarity, FIG. 3 is discussed in the context of FIG. 1.

Computing system 320 may use UI devices 360 to enable computing system 320 to receive user input and provide output to one or more users. UI devices 360 may be implemented using various technologies. For example, UI devices 360 may be configured to receive input from a user through tactile, audio, and/or video feedback. In another example, UI devices 360 may be configured to provide output to a user through tactile, audio, and/or video output.

UI devices 360 may include input devices 362 and output devices 364. Input devices 362 may include one or more devices and/or components configured to receive user input. For example, input devices 362 may include one or more input devices such as presence-sensitive displays, presence-sensitive or touch-sensitive input devices, mice, keyboards, voice responsive systems, video cameras, microphones or any other types of devices for detecting input from a user. Output devices 364 may include one or more devices and/or components capable of generating output. For example, output devices 242 may include one or more output devices capable of generating tactile, video, and/or video output such as displays, speakers, haptic engines, light indicators, or any other types of devices capable of generating output.

Computing system 320 may use one or more processors 366 to implement functionality and/or execute instructions within computing system 320. Examples of processors 366 include, but are not limited to, one or more digital signal processors (DSPs), general purpose microprocessors, application specific integrated circuits (ASICs), field programmable logic arrays (FPGAs), or other equivalent integrated or discrete logic circuitry. Processors 366 may process information received from one or more sources such as external computing systems via one or more interfaces of communication units 368.

Computing system 320 may use communication units 368 to communicate with one or more external devices/systems via one or more wired and/or wireless networks by transmitting and/or receiving network signals on the one or more networks. Examples of communication units 368 may include a network interface card (e.g., such as Ethernet card), an optical transceiver, a radio frequency transceiver, a GPS receiver, a telephony interface, or any other type of device that can send and/or receive information. Other examples of communication units 368 may include short wave radios, cellular data radios, wireless network radios, satellite communication radios, as well as universal serial bus (USB) controllers.

Computing system 320 may use communication channels 370 to facilitate communication between one or components of computing system 320. Communication channels 370 may include one or more hardware and software communications and/or interfaces that physically and/or logically interconnect one or more components and/or devices of computing system 320. For example, communication channels 370 may communicate instructions from software components stored by storage devices 372 to processors 366 for execution.

Computing system 320 may store instructions and information in storage devices 372. Storage devices 372 may include one or more types of computer-readable storage media. For example, storage devices 372 may include one or more types of non-volatile storage devices such hard disk drives, solid state drives, optical discs, magnetic tape drives, cloud storage, and other types of non-volatile storage. In addition, storage devices 372 may include one or more types of volatile storage such as random access memory (RAM), dynamic random access memory (DRAM), static random access memory (SRAM), and other forms of volatile memory known in the art.

Storage devices 372 may store instructions and information of operating system 328 (hereinafter “OS 328”). OS 328 may be an operating system executed by computing system 320 to provide an execution environment for one or more software components of computing system 320. For example, OS 328 may facilitate the execution of remote intent analyzer 326.

Storage device 372 may store information in database 324. Database 324 may include one or more databases or other types of data storage/structure maintained by computing system 320. For example, database 324 may include a collection of physical storage assigned to computing system 320 and configured to store information for computing system 320. In another example, database 324 may include cloud storage associated with computing system 320 and configured to store information for use by one or more components of computing system 320. Database 324 may store information such information regarding use of storefront application 108 by a user of computing device 100. For example, computing system 320 may receive information regarding the most recent page displayed by storefront application 108, the last time storefront application 108 was launched by computing device 100, user interactions with storefront application 108 (e.g., “clicks” within storefront application 108), usage statistics regarding which applications and games a user of computing device 100 uses on computing device 100, and other information. In some examples, computing system 320 may receive information from a plurality of computing devices and store the information in database 324.

Storage device 372 may include user segmentation module 374. User segmentation module 374 may be a program, plugin, module, or other type of process/software component. Computing system 320 may execute the instructions of user segmentation module 374 to generate user segments and/or to determine a user segment to associate with a user of computing device 100. In some examples, user segmentation module 374 may process information regarding a plurality of users of storefront application 108 across a plurality of computing devices such as computing device 100 and generate user segmentation data. User segmentation module 374 may generate user segmentation data that segments users into one or more user segments based on characteristics of the users and usage information associated with the users. For example, user segmentation module 374 may generate user segments based on information regarding how a plurality of users interact with storefront application 108 (e.g., what the users click on within storefront application 108, what applications they download, what purchases they make within storefront application 108, etc.) and information regarding the characteristics of the users (e.g., aggregated age, interests, geographic region, etc.).

Storage devices 372 may store information regarding user segmentation and aggregated user statistics in database 124. Computing system 320 may receive information regarding user segmentation and aggregated user statistics from one or more computing systems such as computing system associated with storefront application 108 and/or information regarding user segmentation generated by user segmentation module 374. For example, computing system 320 may receive user segmentation information that includes information regarding a plurality of user segments that are based on characteristics of users of storefront application and usage information of the users. In an example, computing system 320 receives user segmentation information that includes information regarding the segmentation of users who play games acquired from storefront application 108 into segments of users who play action games, users who play puzzle games, and users who play strategy games. Computing system 320 may store user segmentation information for use by one or more components of computing system 320 such as remote intent analyzer 326.

Storage devices 372 may store instructions of remote intent analyzer 326. Computing system 320 may execute the instructions of remote intent analyzer 326 to determine an intent of a user of a computing device such as computing device 100. For example, remote intent analyzer 326 may be a software component of computing system 320 that is configured to determine the intent of a user of computing device 100 in the context of determining which page of an application such as storefront application 108. In some examples, remote intent analyzer 326 may work in tandem with intent analyzer 112 in determining the intent of a user. In additional examples, remote intent analyzer 326 may determine the intent of the user instead of a software component of computing device 100 such as intent analyzer 112.

Remote intent analyzer 326 may use one or more types of information to determine the intent of a user of computing device 100. Remote intent analyzer 326 may use information similar to information used by intent analyzer 112 to determine the intent of the user. Remote intent analyzer 326 may use information stored in database 324 and/or information stored by computing device 100. For example, remote intent analyzer 326 may use information such as a record of the page of storefront application 108 that the user last visited. In another example, remote intent analyzer 326 uses information regarding when the user last used storefront application 108 and which applications the user caused storefront application 108 to obtain for computing device 100. In yet another example, remote intent analyzer 326 may use information regarding segments of users to determine an intent of a user of computing device 100.

Remote intent analyzer 326 may use one or more ML models such as remote ML model 322 to process information and generate intent scores that reflect the intent of a user in seeking one or more pages of storefront application 108. Remote ML model 322 may be similar to local ML model 110 and provide similar functionality. For example, remote ML model 322 may include an ML model such as a shared tower model. In some examples, computing device 100 may use remote ML model 322 to generate the intent score, as computing system 320 may be capable of executing more sophisticated ML models than computing device 100. For example, computing device 100 may provide an indication to computing system 320 to use remote ML model 322 to generate at least one intent score.

Remote ML model 322 may generate at least one intent score that reflects user intent using usage information from one or more sources. Remote ML model 322 may generate intent scores that reflect the intent of a user in seeking one or more pages of storefront application 108. Remote ML 322 process usage information and generate one or more intent scores that are numerical representations of the intent of the user in seeking one or more pages of storefront application 108. For example, remote ML model 322 may generate an application intent score that reflects the intent of the user in seeking a page of storefront application 108 that includes applications available for download from storefront application 108. In another example, remote ML model 322 may generate an application intent score, a media intent score, and a games intent score that each represent a respective page of storefront application 108. In some examples remote ML model 322 may generate intent sub-scores that reflect the intent of the user in seeking one or more sub-pages of storefront application 108.

Remote intent analyzer 326 may provide the intent score and the intent sub-scores to computing device 100. Remote intent analyzer 326 may provide the intent scores and intent sub-scores for computing device 100 to process and determine one or more of navigation settings 114 of storefront application 108. In an example, remote intent analyzer 326 determines at least one intent score using remote ML model 322. Remote intent analyzer 326 causes one or more of communication units 368 to transmit the at least one intent score to computing device 100 for use by computing device 100 in determining one or more of navigation settings 114. In some examples, remote intent analyzer 326 may determine one or more of navigation settings 114 and provide an indication of navigation settings 114 to computing device 100.

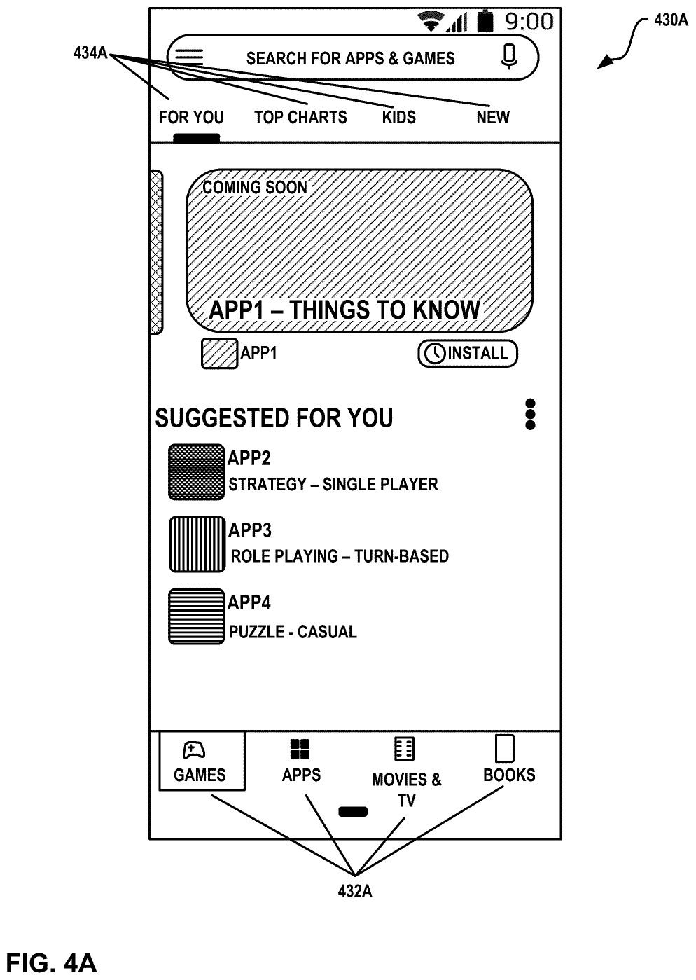

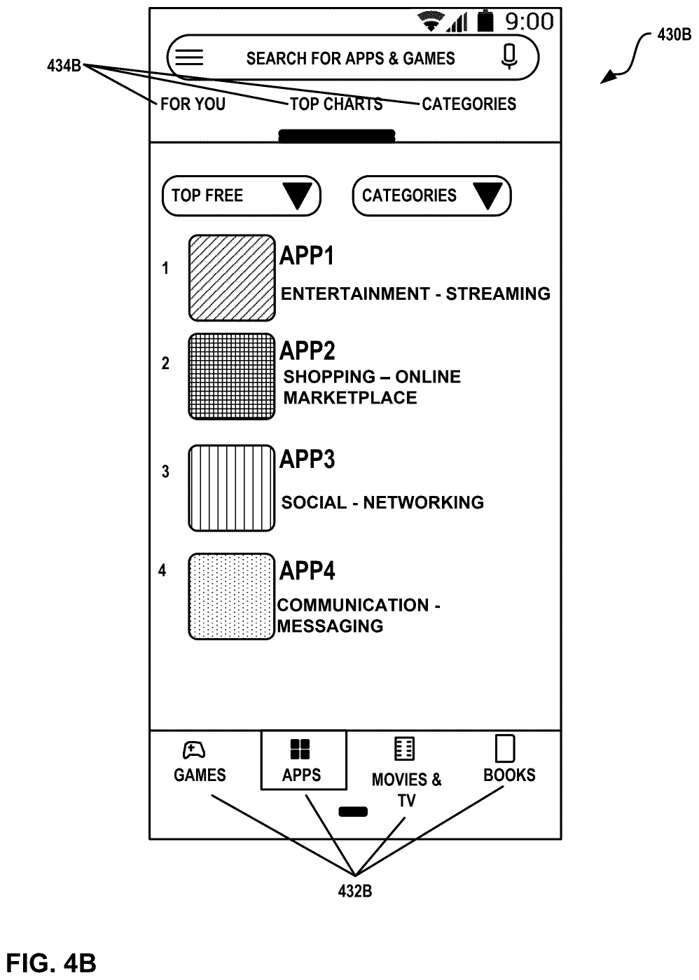

FIGS. 4A-4B are conceptual diagrams illustrating graphical user interfaces of an application, in accordance with one or more techniques of this disclosure. For the purposes of clarity, FIGS. 4A-4B are described in the context of FIG. 1.

One or more software components of computing device 100, such as storefront application 108, may generate GUIs. Storefront application 108 may generate a GUI to facilitate user interaction with storefront application 108 and to display information to a user. For example, storefront application 108 may generate a GUI to display information about electronics available for purchase through storefront application 108 and to facilitate user interaction such as purchasing electronics using computing device 100. In another example, a media player executed by computing device 100 generates a GUI that includes one or more visual elements and that facilitates the playing of media by computing device 100.

Computing device 100 may output a GUI generated by one or more software components for display. Computing device 100 may output the GUI for display via one or more components such as UI device 102. For example, computing device 100 may output a GUI for display via a touchscreen display of UI device 102. In another example, storefront application 108 generates a GUI as including one or more visual elements that correspond to items of clothing offered for sale via storefront application 108. Computing device 100 causes UI device 102 to output the GUI for display. Computing device 100 may integrate one or more visual elements of an operating system of computing device 100 into the GUI generated by a software component of computing device 100 such as storefront application 108 (e.g., add one or more visual indicators of system status, add a visual element for navigating between applications of computing device 100, etc.).

Computing device 100 may use UI device 102 to facilitate user interaction with a GUI. Computing device 100 may output a GUI for display via UI device 102 and determine whether UI device 102 receives any user input that corresponds to the relative location of one or more visual elements. In an example, computing device 100 causes UI device 102 to output a GUI for display, where the GUI includes several visual elements that display applications for download and several visual elements that facilitate navigation among the pages of an application such as storefront application 108. Based on received user input, UI device 102 determines that a user has selected a visual element that facilitates navigation to a second page of storefront application 108. Storefront application 108 generates a second GUI that includes the second page of storefront application 108 and causes UI device 102 to output the second GUI for display.

In the example of FIG. 4A, storefront application 108 of computing device 100 generates GUI 430A as including a plurality of visual elements. Storefront application 108 may generate GUI 430A as incorporating one or more visual elements generated by an operating system of computing device 100. For example, storefront application 108 may incorporate visual elements that indicate the status of computing device 100 (e.g., a battery percentage indicator, a cellular signal strength indicator, a WIFI signal strength indicator, etc.), a visual element that facilitates navigation of the GUI of the operating system (e.g., a pill-shaped visual element visually located near the bottom of GUI 430A), and a system clock into GUI 430A.

Storefront application 108 may generate GUI 430 as including a page of storefront application 108. For example, storefront application 108 may generate GUI 430A as including a page that includes information about different games that are available for purchase and acquisition through storefront application 108. In another example, storefront application 108 may generate GUI 430 as including visual indicators of games that are recommended for a user (e.g., the visual indicator that includes “SUGGESTED FOR YOU” and listing of applications that can be installed along with the respective names and genres of the games). In yet another example, storefront application 108 generates GUI 430A as including visual elements resembling visual cards that indicate newly released applications (e.g., the visual card that includes the label “APP1—THINGS TO KNOW” and “COMING SOON”) and a visual element that corresponds to an option to install the applications.

Storefront application 108 may generate GUI 430A as including one or more visual elements that enable a user to navigate storefront application 108. For example, storefront application 108 may generate GUI 430A as including navigation tabs 432A. Navigation tabs 432A may be visual elements of GUI 430A that, when interacted with by a user via UI device 102, enable a user to navigate between different pages of storefront application 108. For example, storefront application 108 may use navigation tabs 432 to enable a user to navigate from a page of storefront application 108 that displays games to a page of storefront application 108 that displays movies and television shows for purchase. In another example, computing device 100 receives user input consistent with a user interacting with a navigation tab of navigation tabs 432 that corresponds to a page of storefront application 108 that includes a number of books available for purchase. Based on the received user input, storefront application 108 generates an updated instance of GUI 430A to include the page that displays the books available for purchase.

Storefront application 108 may generate GUI 430A as including one or more visual elements that enable a user to navigate among one or more sub-pages of storefront application 108. Storefront application 108 may include one or more sub-pages of pages of storefront application 108 that include information regarding subsets of offerings of pages of storefront application 108. For example, storefront application 108 may include sub-pages of a men's fashion page that are men's jackets sub-pages, men's sunglasses sub-pages, and other sub-pages that include subsets of the offerings of the men's fashion page. Storefront application 108 may generate GUI 430A as including sub-tabs 434A that are visual elements to enable a user to navigate among the sub-pages. For example, sub-tabs 434A may enable a user to navigate from a sub-page that displays various nonfiction e-books available for purchase to sub-pages that display science fiction e-books and fantasy e-books available for purchase. In another example, sub-tabs 434A enable a user to navigate between sub-pages of storefront application 108 that display apps selected based on user interest (e.g., the “FOR YOU” sub-tab illustrated by FIG. 4A), charts of the top applications (e.g., the “TOP CHARTS” sub-tab illustrated by FIG. 4A), applications intended for children (e.g., the “KIDS” sub-tab illustrated by FIG. 4A), and newly released applications (e.g., the “NEW” sub-tab illustrated by FIG. 4A).

Storefront application 108 may generate updated instances of GUI 430A in response to the receipt of user input. Storefront application 108 may generate updated instances of GUI 430A that are based on user interaction with one or more of the visual elements that enable user navigation of storefront application 108. In an example, computing device 100 receives user input via UI device 102 and determines that the user has interacted with a tab of tabs 432A that corresponds to a visual media page of storefront application 108 (e.g., a tab labeled as “MOVIES & TV”). Based on the determination regarding user interaction, storefront application 108 generates an updated instance of GUI 430A that includes a page that includes a plurality of visual media offered through storefront application 108. UI device 102 outputs the updated instance of GUI 430A for display to the user.

Computing device 100 may record information regarding user interactions with tabs 432A and sub-tabs 434A. Computing device 100 may record information regarding user interactions such as user selection of one or more of tabs 432A and sub-tabs 434A to navigate between the pages and sub-pages of storefront application 108. For example, computing device 100 may record the user interacting with (e.g., “clicking”) a tab of tabs 432A to navigate to a page of storefront application 108 that includes information regarding e-books available for purchase through storefront application 108. Computing device 100 may use information regarding the user interactions to determine which page of storefront application 108 should open upon launching of storefront application 108.

In the example of FIG. 4B, storefront application 108 generates GUI 430B as including a plurality of visual elements. Similar to the discussion regarding FIG. 4A, storefront application 108 may generate GUI 430B as incorporating visual elements generated by an operating system of computing device 100 and visual elements generated by storefront application 108. For example, computing device 100 may generate GUI 430B as including visual elements of a GUI of the operating system such as a system clock and battery status indicator and including visual elements of a GUI of storefront application 108 such as visual elements that correspond to applications available for download from storefront application 108.

Storefront application 108 may generate GUI 430B as including a page of storefront application 108. For example, storefront application 108 may generate GUI 430A as including a page that includes information about different applications available through storefront application 108. In another example, storefront application 108 may generate GUI 430A as including a page of storefront application that includes a visual chart of applications ranked by number of downloads.

Storefront application 108 may generate GUI 430B as including one or more visual elements that enable a user to navigate storefront application 108. Similar to FIG. 4A, storefront application 108 may generate GUI 430B as including visual elements that enable a user to navigate between pages and subpages of storefront application 108. For example, storefront application 108 may generate GUI 430A as including tabs 432B and sub-tabs 434B.

Storefront application 108 may generate GUI 430B as including tabs 432B. Tabs 432B may be visual elements that correspond to one or more pages of storefront application 108 and enable a user to navigate between pages of storefront application 108. For example, storefront application 108 may generate GUI 430B as including four tabs of tabs 432B, where each of the four tabs corresponds to a different respective page of storefront application 108.

Storefront application 108 may generate GUI 430B as including one or more of sub-tabs 434B. Sub-tabs 434B may be visual elements that correspond to one or more sub-pages of storefront application 108. For example, storefront application 108 may generate GUI 430B as including three sub-tabs of tabs 432B, where each of the sub-tabs corresponds to a respective sub-page of storefront application 108. In another example, storefront application 108 generates GUI 430B as including a first sub-tab labeled as “FOR YOU”, a second sub-tab labeled as “TOP CHARTS” and a third sub-tab labeled as “CATEGORIES”.

Storefront application 108 may generate a first instance of GUI 430B upon launch of storefront application 108. Storefront application 108 may determine which page to open upon launch of storefront application 108 based on the information of navigation settings 114. In an example, computing device 100 causes storefront application 108 to launch in response to receiving user input. Prior to generating GUI 430B, storefront application 108 obtains information from navigation settings 114 to determine which page storefront application 108 should open. Storefront application 108 determines the page that should open and generates GUI 430B as including the page. UI device 102 displays GUI 430B via one or more output devices.

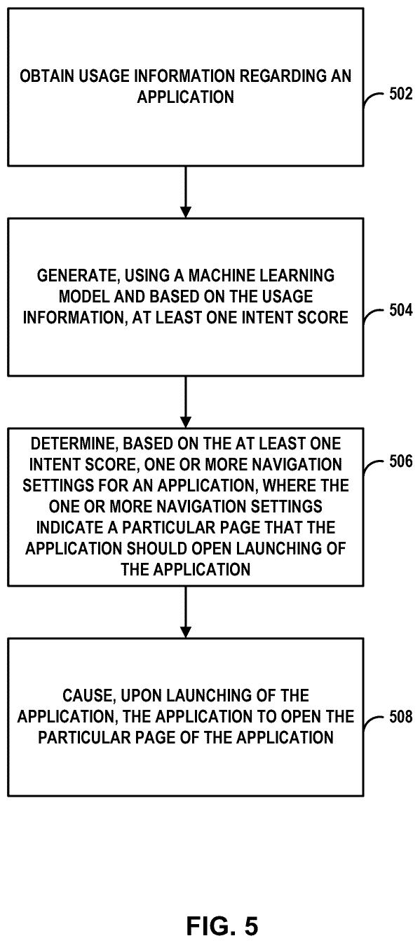

FIG. 5 is a flow diagram illustrating example operations of an example computing device for determining navigation settings for an application, in accordance with one or more techniques of the present disclosure. For the purposes of clarity, FIG. 5 is discussed in the context of FIG. 1.

A computing device, such computing device 100, obtains usage information regarding applications such as storefront application 108 (502). Computing device 100 may obtain usage information that includes information regarding when and how a user of computing device 100 has interacted with computing device 100. For example, computing device 100 may obtain usage information that includes information regarding which page of storefront application 108 the user last visited, what offerings of storefront application 108 the user has received (e.g., downloading applications, ordering food delivery, renting movies, etc.), usage information of applications and/or games executed by computing device 100 (e.g., what applications and games the user uses on computing device 100), and other information. In some examples, computing device 100 may obtain usage information from an external computing system such as a computing system associated with storefront application 108.

Computing device 100 generates, using a machine learning (ML) model such as local ML model 110 and based on usage information, at least one intent score (504). Computing device 100 may use an ML model that is executed on device (e.g., local ML model 110) and/or an ML model that is located off device on an external computing system such as computing system 120 (e.g., using remote ML model 122). Computing device 100 may generate one or more intent scores using a software component such as intent analyzer 112, where each intent score reflects the intent of a user in seeking one or more products/services provided by storefront application 108. For example, computing device 100 may use intent analyzer 112 to determine an application intent score that reflects an intent of the user in seeking applications from storefront application 108 and a game intent score that reflects an intent of the user in seeking games from storefront application 108. In some examples, computing device 100 may generate intent sub-scores that are indicative of user intent within an intent score. For example, computing device 100 may generate an intent sub-score that reflects a user seeking strategy games within the game intent score. In another example, computing device 100 generates an intent sub-score that reflects a user seeking men's watches within a men's clothing intent score. In yet another example, computing device 100 generates a burger intent score within an American food intent score.

Computing device 100 determines, based on the at least one intent score, one or more navigation settings such as navigation settings 114 for storefront application 108, where one or more of navigation settings 114 indicate a particular page that storefront application 108 should upon open launching of storefront application 108 (506). Computing device 100 may determine navigation settings 114 that manage the configuration and presentation of pages of storefront application 108. For example, navigation settings 114 may include one or more settings of storefront application 108 that determine which page storefront application 108 first displays when computing device 100 launches storefront application 108. Computing device 100 may use the at least one intent score to determine navigation settings 114. For example, computing device 100 may determine that the at least one intent score reaches a predetermined threshold of value that reflects a user seeking content that is displayed via a particular page of storefront application 108. In another example, computing device 100 compares two or more intent scores and determines the intent of the user based on whichever intent score has a higher numerical value. Computing device 100 may modify navigation settings to cause storefront application 108 to open to a particular page of storefront application 108. In an example, based on a game intent score computing device 100 determines that storefront application 108 should open to a page that includes a plurality of games available through storefront application 108. Computing device 100 modifies one or more settings of navigation settings 114 to cause storefront application 108 to open to the page that includes a plurality of games upon launch of storefront application 108. Computing device 100 may compare two intent scores, where each intent score corresponds to a page, as part of determining which page of storefront application 108 should open upon launching of storefront application 108.

Computing device 100 causes, upon launching of storefront application 108, storefront application 108 to open the particular page of storefront application 108 (508). Computing device 100 may cause storefront application 108 to read information stored in navigation settings 114 while launching to determine which page to display. Storefront application 108 may read the information in navigation settings 114 and open to the particular page. In an example, a user provides input to computing device 100 to indicate that computing device 100 should open storefront application 108. Storefront application 108 reads information from navigation settings 114 and determines that storefront application 108 should open to a particular page. Storefront application 108 generates GUI 130 as including the page and causes UI device 102 to display GUI 130.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
obtaining, by a computing device, usage information for an application;
generating, by the computing device and using a machine learning model and based on the usage information, at least one intent score;
determining, by the computing device and based on the at least one intent score, one or more navigation settings for the application, wherein the one or more navigation settings indicate a particular page that the application should open upon launching of the application; and
causing, by the computing device and upon launching of the application, the application to open the particular page.

2. The method of claim 1, wherein the at least one intent score includes a game intent score that is indicative of a user seeking games and an application intent score that is indicative of the user seeking applications.

3. The method of claim 2, wherein the machine learning model is a shared tower model, and wherein the machine learning model includes a first independent tower for determining the game intent score and a second independent tower for determining the application intent score, and wherein generating the at least one intent score further comprises:
providing the usage information to the machine learning model; and
receiving, from the machine learning model, the game intent score from the first independent tower and the app intent score from the second independent tower.

4. The method of claim 1, further comprising weighting, by the computing device, the at least one intent score based on one or more factors.

5. The method of claim 1, further comprising:
outputting, by the computing device and for display via one or more display components, the particular page of the application.

6. The method of claim 1, further comprising:
determining, by the computing device, whether the application has been accessed within an immediately preceding period of time; and
responsive to determining that the application had been accessed within the immediately preceding period of time, determining, by the computing device, which page of the application was last accessed,
wherein causing the application to open the particular page further comprises causing the application to open the page of the application that was last accessed.

7. The method of claim 1, wherein the at least one intent score includes at least one intent sub-score, wherein the at least one intent sub-score is a sub-score indicative of user interest within a game category or app category of the application, and wherein the one or more navigation settings include a first one or more navigation settings, the method further comprising:
determining, by the computing device and based on the at least one intent sub-score, one or more second navigation settings, wherein the one or more second navigation settings indicate a particular subpage that the application should open upon launching of the application.

8. The method of claim 7, wherein the at least one intent sub-score corresponds to a segment of users of a plurality of segments of users.

9. The method of claim 1, further comprising:
obtaining, by the computing device, an indication of which page of the application should be opened upon launch of the application from a computing system.

10. The method of claim 1, wherein generating the at least one intent score includes:
providing, by the computing device and to the machine learning model, the usage information as an input; and
obtaining, from the machine learning model, an output that includes the at least one intent score generated by the machine learning model using the input.

11. A computing device, comprising:
a memory, and
one or more programmable processors in communication with the memory and configured to:
obtain usage information for an application;
generate, using a machine learning model and based on the usage information, at least one intent score;
determine, based on the at least one intent score, one or more navigation settings for the application, wherein the one or more navigation settings indicate a particular page that the application should open upon launching of the application; and
cause, upon launching of the application, the application to open the particular page.

12. The computing device of claim 11, wherein the at least one intent score includes a game intent score that is indicative of a user seeking games and an application intent score that is indicative of the user seeking applications.

13. The computing device of claim 12, wherein the machine learning model is a shared tower model, and wherein the machine learning model includes a first independent tower for determining the game intent score and a second independent tower for determining the application intent score, and wherein to generate the at least one intent score, the one or more programmable processors are further configured to:
provide the usage information to the machine learning model; and
receive, from the machine learning model, the game intent score from the first independent tower and the app intent score from the second independent tower.

14. The computing device of claim 11, wherein the one or more programmable processors are further configured to:
determine whether the application has been accessed within an immediately preceding period of time; and
responsive to determining that the application had been accessed within the immediately preceding period of time, determine which page of the application was last accessed,
wherein to cause the application to open the particular page, the one or more programmable processors are configured to cause the application to open the page of the application that was last accessed.

15. The computing device of claim 11, wherein the at least one intent score includes at least one intent sub-score, the at least one intent sub-score is a sub-score indicative of user interest within a game category or app category of the application, the one or more navigation settings include a first one or more navigation settings, and the one or more programmable processors are further configured to:
determine, based on the at least one intent sub-score, one or more second navigation settings, wherein the one or more second navigation settings indicate a particular subpage that the application should open upon launching of the application.

16. A non-transitory computer-readable storage medium, encoded with instructions that, when executed by one or more processors of a computing device, causes the one or more processors to:
obtain usage information for an application;
generate, using a machine learning model and based on the usage information, at least one intent score;
determine, based on the at least one intent score, one or more navigation settings for the application, wherein the one or more navigation settings indicate a particular page that the application should open upon launching of the application; and
cause, upon launching of the application, the application to open the particular page.

17. The non-transitory computer-readable storage medium of claim 16, wherein the at least one intent score includes a game intent score that is indicative of a user seeking games and an application intent score that is indicative of the user seeking applications.

18. The non-transitory computer-readable storage medium of claim 17, wherein the machine learning model is a shared tower model, and wherein the machine learning model includes a first independent tower for determining the game intent score and a second independent tower for determining the application intent score, and wherein to generate the at least one intent score, the instructions further cause the one or more processors to:
provide the usage information to the machine learning model; and
receive, from the machine learning model, the game intent score from the first independent tower and the app intent score from the second independent tower.

19. The non-transitory computer-readable storage medium of claim 16, wherein the instructions further cause the one or more processors to:
determine whether the application has been accessed within an immediately preceding period of time; and
responsive to determining that the application had been accessed within the immediately preceding period of time, determine which page of the application was last accessed,
wherein to cause the application to open the particular page, the instructions further the one or more processors to cause the application to open the page of the application that was last accessed.

20. The non-transitory computer-readable storage medium of claim 16, wherein the at least one intent score includes at least one intent sub-score, the at least one intent sub-score is a sub-score indicative of user interest within a game category or app category of the application, the one or more navigation settings include a first one or more navigation settings, and the instructions further cause the one or more processors to:
determine, based on the at least one intent sub-score, one or more second navigation settings, wherein the one or more second navigation settings indicate a particular subpage that the application should open upon launching of the application.
